(19) United States
(12) Patent Application Publication
(10) Pub. No.: US 2016/0260950 A1
(43) Pub. Date: Sep. 8, 2016

(54) BATTERY PACK

(71) Applicant: SAMSUNG SDI CO., LTD., Yongin-si (KR)

(72) Inventors: Woonseong Baek, Yongin-si (KR); Sejin Ji, Yongin-si (KR); Sangkyou Kim, Yongin-si (KR); Hyeoncheol Jeong, Yongin-si (KR)

(21) Appl. No.: 14/857,417

(22) Filed: Sep. 17, 2015

(30) Foreign Application Priority Data
Mar. 5, 2015 (KR) 10-2015-0031112

(51) Int. Cl. H01M 2/20

(52) U.S. Cl. CPC H01M 2/206; H01M 2220/20; H01M 2220/10

(57) ABSTRACT

A battery pack includes a plurality of bare cells; a housing into which the bare cells are inserted in a first direction; an electrode tab in contact with edge portions of first ends of bare cells of the plurality of bare cells and including a plurality of openings; a plurality of electrode blocks arranged at both ends of the bare cells; and electrode terminals directly connected to electrode blocks of the plurality of electrode blocks to allow the bare cells to be connected to an external device.

### CROSS-REFERENCE TO RELATED APPLICATION

This application claims priority to and the benefit of Korean Patent Application No. 10-2015-0031112, filed on Mar. 5, 2015 in the Korean Intellectual Property Office, the entire content of which is incorporated herein by reference.

### BACKGROUND

1. Field

Aspects of embodiments of the present invention relate to a battery pack.

2. Description of the Related Art

Unlike primary batteries, secondary batteries are rechargeable. According to the types of devices that employ secondary batteries, secondary batteries are used as individual units or in the form of battery modules each including a plurality of secondary batteries connected to one another to form a unit.

Lead-acid batteries of the related art, which have been widely used in vehicles or other industrial applications, are rechargeable batteries including a negative electrode formed of lead (Pb), a positive electrode formed of lead dioxide (PbO₂), and an electrolyte formed of sulfuric acid (H₂SO₄) and having a specific gravity of about 1.25.

Lead-acid batteries may be classified into industrial lead-acid batteries and automotive lead-acid batteries. Industrial lead-acid batteries are mainly used as power storage systems for solar batteries or standby power sources of electronic devices or communication facilities. Automotive lead-acid batteries are mainly used in automobiles, motorcycles, golf cars, ships, and electric vehicles as starting batteries or power sources.

Along with the trend of developing small and/or lightweight products, batteries that supply power to such products are also required to have small and/or lightweight features. Particularly, since lead-acid batteries use environmentally harmful lead and dangerous sulfuric acid, new lead-acid battery packs with a high degree of safety and eco-friendly features are under development.

### SUMMARY

Aspects of one or more exemplary embodiments of the present invention relate to a battery pack.

Additional aspects will be set forth in part in the description which follows and, in part, will be apparent from the description, or may be learned by practice of the presented embodiments.

According to one or more exemplary embodiments of the present invention, a battery pack includes: a plurality of bare cells; a housing into which the bare cells are inserted in a first direction; an electrode tab in contact with edge portions of first ends of bare cells of the plurality of bare cells and including a plurality of openings; a plurality of electrode blocks arranged at both ends of the bare cells; and electrode terminals directly connected to electrode blocks of the plurality of electrode blocks to allow the bare cells to be connected to an external device.

Each of the electrode blocks may include: a protrusion; and a slot proximate to the protrusion to allow a region of the electrode block including the protrusion to undergo an elastic deformation.

Each of the electrode blocks may further include a connection portion extending toward an electrode terminal of the electrode terminals and being directly connected to the electrode terminal.

Each of the electrode blocks may include a plurality of protrusions including the protrusion, protrusions of the plurality of protrusions being positioned in openings of the plurality of openings of the electrode tab.

The protrusions may contact the first ends of the bare cells through the openings of the electrode tab.

The battery pack may further include a case unit into which the housing is inserted in a second direction different from the first direction.

The battery pack may further include an insulation cover disposed between the housing and the case unit such that the electrode blocks contact the bare cells.

According to one or more exemplary embodiments of the present invention, a battery pack includes: a housing; a first bare cell unit inserted into the housing such that a first polarity end of the first bare cell unit is arranged at a first side of the housing; a second bare cell unit inserted into the housing such that the second bare cell unit is arranged proximate to the first bare cell unit and a first polarity end of the second bare cell unit is arranged at a second side of the housing; an electrode tab in contact with an edge portion of the first polarity end of the first bare cell unit and including a plurality of openings; electrode terminals extending to an outer side of the housing to allow the first bare cell unit and the second bare cell unit to be connected to an external device; and at least one electrode block electrically connecting the first and second bare cell units to each other or electrically connecting the first and second bare cell units to the electrode terminals.

Each of the at least one electrode block may include: a protrusion; and a slot proximate to the protrusion to allow a region of the electrode block including the protrusion to undergo an elastic deformation.

Each of the at least one electrode blocks may include a plurality of protrusions including the protrusion, protrusions of the plurality of protrusions being positioned in openings of the plurality of openings of the electrode tab.

The protrusions may contact the end of the first bare cell unit through the openings of the electrode tab.

The first and second bare cell units may be connected in series.

### BRIEF DESCRIPTION OF THE DRAWINGS

These and/or other aspects will become apparent and more readily appreciated from the following description of some exemplary embodiments of the present invention, taken in conjunction with the accompanying drawings, in which:

FIG. 1 is an exploded schematic perspective view illustrating a battery pack according to an exemplary embodiment;

FIG. 2 is an exploded schematic perspective view illustrating a portion of the battery pack depicted in FIG. 1;

FIG. 3 is a perspective view illustrating an electrode block of the battery pack depicted in FIG. 1;

FIG. 4 is a cross-sectional view illustrating a coupled state of an electrode block depicted in FIG. 2;

FIG. 5 is a front view illustrating the battery pack depicted in FIG. 1; and

FIG. 6 is a rear view illustrating the battery pack depicted in FIG. 1.

### DETAILED DESCRIPTION

Reference will now be made in further detail to some exemplary embodiments of the present invention, examples of which are illustrated in the accompanying drawings. Effects and features of the exemplary embodiments, and implementation methods thereof will be further clarified through the following descriptions given with reference to the accompanying drawings. In this regard, embodiments of the present invention may have different forms and should not be construed as being limited to the descriptions set forth herein. As used herein, the term “and/or” includes any and all combinations of one or more of the associated listed items.

Hereinafter, some exemplary embodiments of the present invention will be described in further detail with reference to the accompanying drawings. In the drawings, like reference numerals denote like elements, and overlapping descriptions thereof will be omitted.

In the following descriptions of some exemplary embodiments of the present invention, although the terms “first” and “second” may be used to describe various elements, these elements should not be limited by these terms. These terms are only used to distinguish one element from another element.

In the following descriptions of some exemplary embodiments of the present invention, terms of a singular form may include plural forms unless the context clearly indicates otherwise.

In the following descriptions of some exemplary embodiments of the present invention, the terms “include,” “comprise,” “including,” and “comprising” specify a property, a region, a fixed number, a step, a process, an element, a component, and/or a combination thereof but do not exclude other properties, regions, fixed numbers, steps, processes, elements, components, and/or combinations thereof.

It will also be understood that when a film, a region, or an element is referred to as being “above” or “on” another film, region, or element, it can be directly above or on the other film, region, or element, or intervening films, regions, or elements may also be present.

In the following examples, the x-axis, the y-axis, and the z-axis are not limited to the three axes of the rectangular coordinate system, and may be interpreted in a broader sense. For example, the x-axis, the y-axis, and the z-axis may be perpendicular to one another, or may represent different directions that are not perpendicular to one another.

Sizes of elements in the drawings may be exaggerated for convenience of explanation. In other words, since sizes and thicknesses of components in the drawings may be arbitrarily illustrated for convenience of explanation, embodiments of the present invention are not limited thereto.

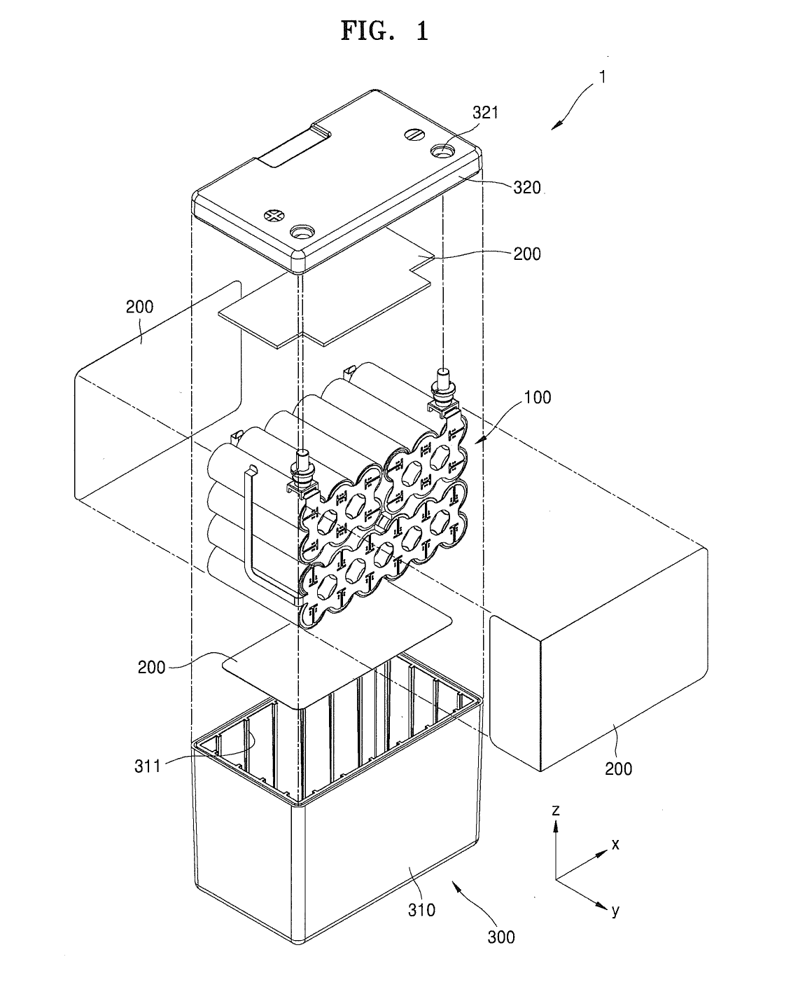

FIG. 1 is an exploded schematic perspective view illustrating a battery pack 1 according to an exemplary embodiment of the present invention.

Referring to FIG. 1, the battery pack 1 may include a battery unit 100 that is rechargeable, insulation covers 200 enclosing the battery unit 100, and a case unit 300 accommodating the battery unit 100.

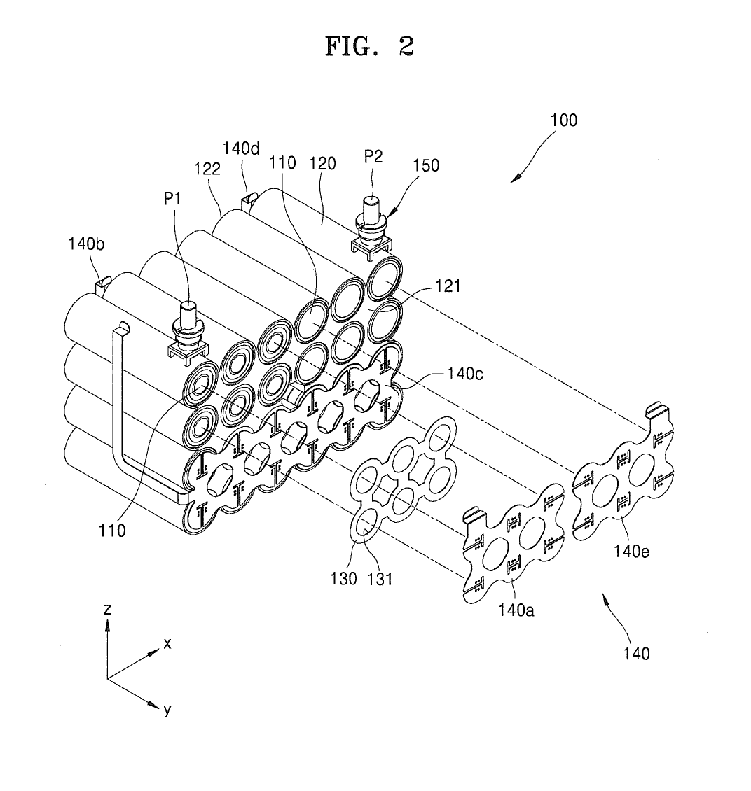

The battery unit 100 may include a plurality of bare cells 110 connected to each other. The bare cells 110 may receive a charge current and output a discharge current. The bare cells 110 of the battery unit 100 may be rechargeable secondary battery cells, such as lithium-ion battery cells. The battery unit 100 will be described later in more detail with reference to FIGS. 2 to 4.

The insulation covers 200 may be formed of an insulation material and may enclose outer sides of the battery unit 100. The insulation covers 200 may be disposed between a housing 120 (refer to FIG. 2) and the case unit 300 to push electrode blocks 140 (refer to FIG. 2) toward the bare cells 110. In addition, the insulation covers 200 may function as a shock absorbing material when a shock is applied to the battery unit 100. The insulation covers 200 may have a plate shape or may be provided in the form of insulation tape wrapped around the battery unit 100.

The case unit 300, in one embodiment, has a rectangular parallelepiped shape and dustproof and waterproof characteristics. The case unit 300, in one embodiment, may include a first case 310 having a rectangular parallelepiped shape with an open upper side, and a second case 320 closing the open upper side of the first case 310. The case unit 300 may be formed of an insulation material, such as a plastic material. The case unit 300, in one embodiment, may be assembled by applying a thermal bonding material between the first and second cases 310 and 320 and heating the thermal bonding material, such as using ultrasonic waves or a laser beam.

The case unit 300 has an inner space to receive the battery unit 100 and the insulation covers 200. The first case 310 of the case unit 300 may be open in a direction different from a direction in which the bare cells 110 are inserted into the housing 120. Referring to FIG. 2, in one embodiment, the bare cells 110 are inserted into the housing 120 in a y-axis direction (hereinafter referred to as a first direction). Referring to FIG. 1, the battery unit 100 is inserted into the inner space of the case unit 300 in a z-axis direction (hereinafter referred to as a second direction).

That is, the bare cells 110 are inserted into the housing 120 in the first direction, and the bare cells 110 and the housing 120 are inserted into the case unit 300 in the second direction different from the first direction. Since the insertion direction of the bare cells 110 into the housing 120 is different from the insertion direction of the battery unit 100 into the case unit 300, vibration of the bare cells 110 caused by an external force or other conditions may be reduced or minimized.

The bare cells 110 may be moved along openings of the housing 120 in the first direction due to environmental conditions or a force applied thereto. In this case, contact states of electrode terminals 150 may become unstable. However, since the case unit 300 having an open side in the second direction suppresses movement of the bare cells 110 in the first direction, the stability of the battery unit 100 according to an embodiment of the present invention may be improved.

In one embodiment, inner walls of the case unit 300 include ridges 311, and, thus, gaps may be formed between the battery unit 100 and the inner walls of the case unit 300. When the insulation covers 200 are disposed in the case unit 300, the ridges 311 support the insulation covers 200. Air flow paths may be formed between the insulation covers 200 and the inner walls of the case unit 300. Therefore, since air is allowed to flow into the battery unit 100 through the air flow paths, the battery unit 100 may be cooled for preventing or substantially preventing overheating.

The case unit 300 may include holes 321 to receive the electrode terminals 150. The holes 321 may be formed in the second case 320 of the case unit 300 for receiving the electrode terminals 150.

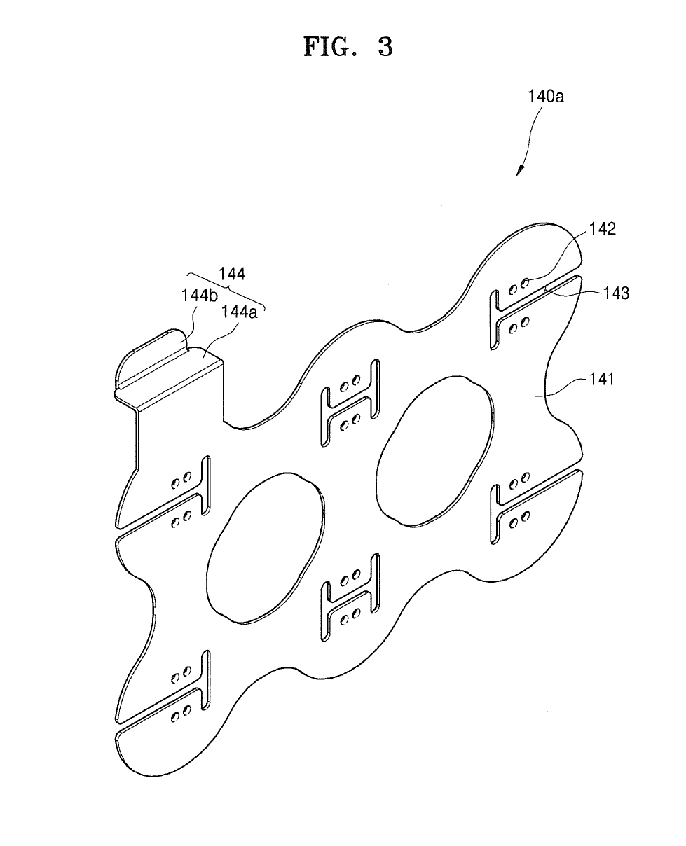

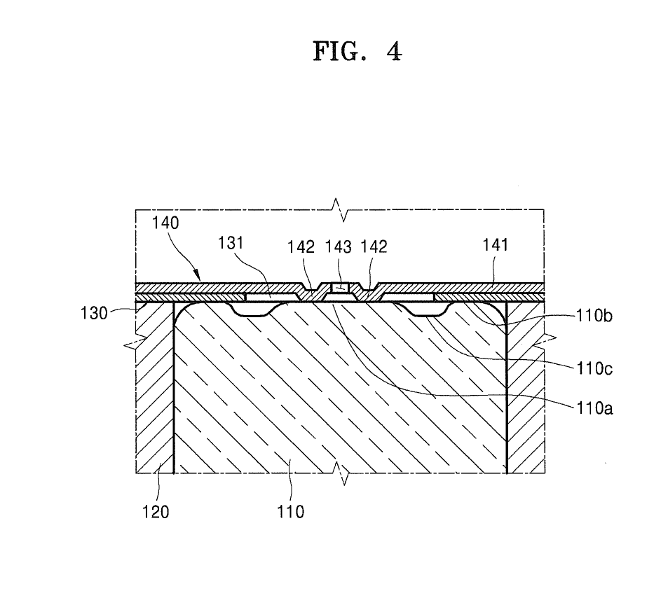

FIG. 2 is an exploded schematic perspective view illustrating a portion of the battery pack 1 depicted in FIG. 1; FIG. 3 is a perspective view illustrating an electrode block 140 of the battery pack 1 depicted in FIG. 1; and FIG. 4 is a cross-sectional view illustrating a coupled state of the electrode block 140 depicted in FIG. 3.

Referring to FIGS. 2 to 4, the battery unit 100 may include the bare cells 110, the housing 120, electrode tabs 130, and the electrode blocks 140.

The bare cells 110 may receive a charge current and output a discharge current through the electrode terminals 150. The bare cells 110 of the battery unit 100 may be connected in series or parallel, or may be connected in series-parallel to adjust the rated charge voltage and rated charge capacity of the battery unit 100. The bare cells 110 may be secondary battery cells, such as lithium-ion battery cells.

In further detail, each of the bare cells 110 may include first and second electrodes having opposite polarities, and the first and second electrodes may be used as electrical contacts for discharging electricity stored in the battery cells 110 and receiving a charge current from outside. A stacked-type electrode assembly (not shown) including positive and negative electrode plates connected to the first and second electrodes and a separator disposed between the positive and negative electrode plates may be disposed in each of the bare cells 110, or a jelly roll-type electrode assembly (not shown) in which positive and negative electrode plates connected to the first and second electrodes and a separator are rolled in the form of a jelly roll may be disposed in each of the bare cells 110.

An end of each of the bare cells 110 may be connected to the first electrode and may have a first polarity, and the other end of each of the bare cells 110 may be connected to the second electrode and may have a second polarity different from the first polarity. The first polarity may be a positive or negative polarity, and the second polarity may be a negative or positive polarity. In the following description, it will be described for purposes of illustration that the first polarity is a positive polarity and the second polarity is a negative polarity.

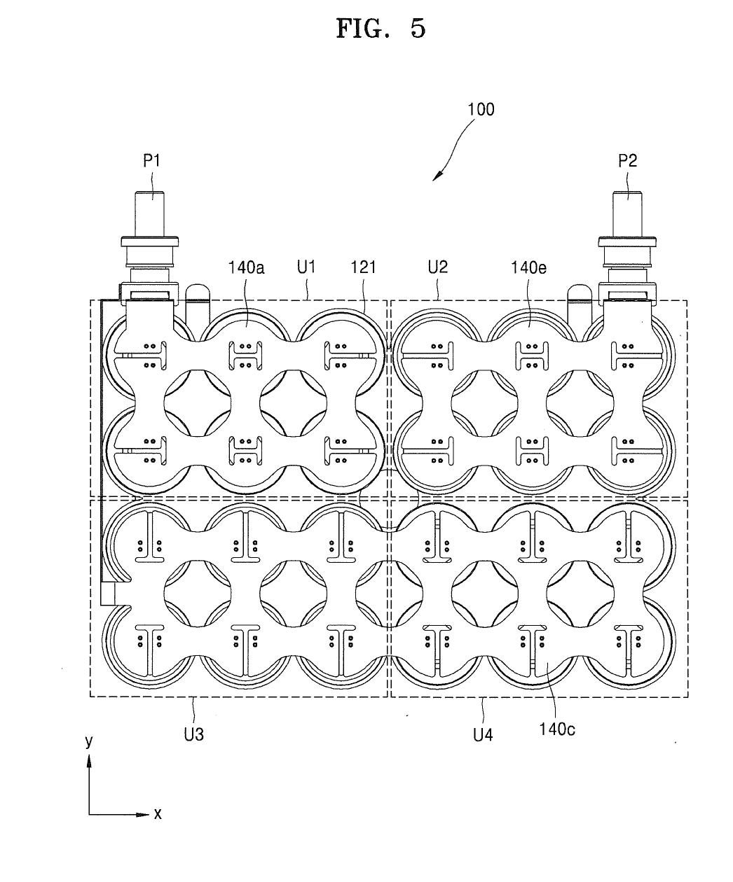

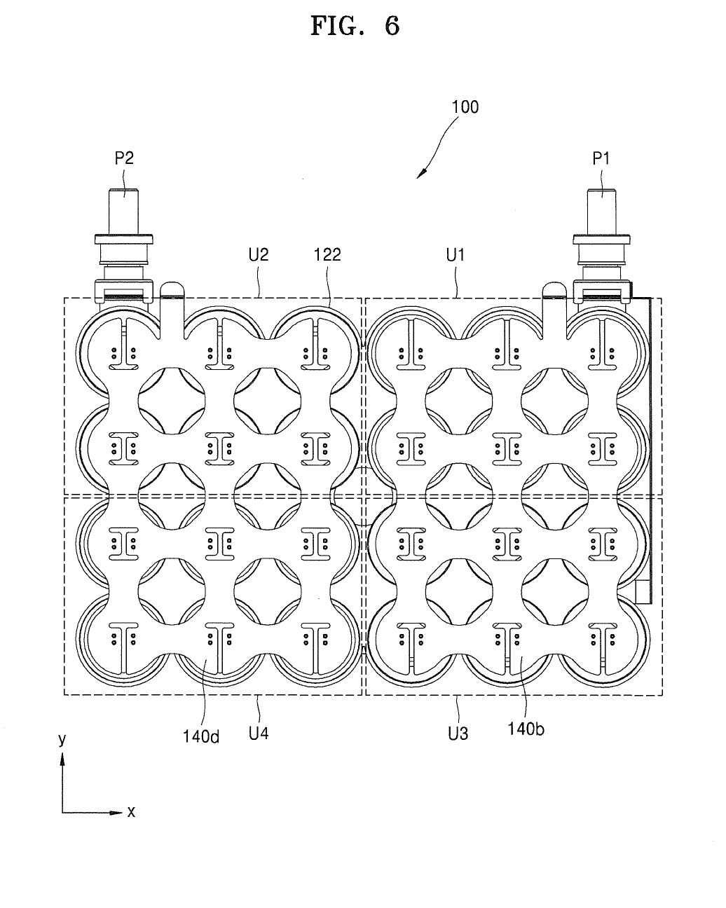

FIG. 5 is a front view illustrating the battery pack 1 depicted in FIG. 1; and FIG. 6 is a rear view illustrating the battery pack 1 depicted in FIG. 1.

Referring to FIGS. 2, 5, and 6, the bare cells 110 may be grouped into a plurality of bare cell units. The number of bare cells 110 included in each of the bare cell units and the number of the bare cell units are not limited according to embodiments of the present invention, but may be varied according to operational conditions and environments of the battery pack 1. However, for purposes of illustration, it will be described herein that, in one embodiment, each of the bare cell units includes six of the bare cells 110 and the battery pack 1 includes four of the bare cell units.

In one embodiment, each of the bare cell units may include a plurality of bare cells 110 connected in parallel. In addition, one or more of the bare cell units may be connected in series with another of the bare cell units.

The battery unit 100 may include a first bare cell unit U1, a second bare cell unit U2, a third bare cell unit U3, and a fourth bare cell unit U4. Each of the bare cell units U1 to U4 may include six of the bare cells 110 connected in parallel. In addition, the first to fourth bare cell units U1 to U4 may be connected in series.

The first and fourth bare cell units U1 and U4 may be inserted into the housing 120 in such a manner that ends of the first and fourth bare cell units U1 and U4, i.e. the ends having the first polarity, are disposed on a first side 121 of the housing 120. The second and third bare cell units U2 and U3 may be inserted into the housing 120 in such a manner that ends of the second and third bare cell units U2 and U3, i.e. the ends having the first polarity, are disposed on a second side 122 of the housing 120. The first and fourth bare cell units U1 and U4 may be disposed in a direction opposite the direction in which the second and third bare cell units U2 and U3 are disposed, and then may be connected through the electrode block 140.

Since the bare cells 110 of each of the bare cell units U1 to U4 are connected in parallel, the lifespan and current output of the battery pack 1 may be increased. Since the bare cell units U1 to U4 are connected in series, the voltage of the battery pack 1 may be increased. That is, the level of voltage output of the battery pack 1 may be adjusted according to the purpose of use of the battery pack 1. For example, an ignition plug or driving plug of a driving device momentarily requires a high voltage. In this case, the bare cell units U1 to U4 of the battery pack 1 may be connected in series so as to provide a high voltage.

The housing 120 includes a plurality of accommodation cavities sized according to the size of the bare cells 110, and the bare cells 110 are respectively disposed in the accommodation cavities. The housing 120 is formed of an insulation material, such as a plastic material, and fixes the bare cells 110. In one embodiment, as shown in FIG. 2, the housing 120 includes twenty-four accommodation cavities, and twenty-four bare cells 110 are disposed in the twenty-four accommodation cavities. However, numbers of the accommodation cavities of the housing 120 and the bare cells 110 are not limited thereto according to embodiments of the present invention. That is, the number of the bare cells 110 disposed in the housing 120 may be varied.

Referring to FIGS. 2 and 4, the electrode tabs 130 may include a plurality of openings 131 and may contact protruding edge portions 110b of the bare cells 110. The electrode tabs 130 may be disposed between ends of the bare cells 110 and the electrode blocks 140. The electrode tabs 130 may maintain the contact between the bare cells 110 and the electrode blocks 140. The electrode tabs 130 may be formed of an insulating material.

Positive electrodes of the bare cells 110 may have a shape different from the shape of negative electrodes of the bare cells 110 and, thus, may be distinguishable from the negative electrodes. Ends of the bare cells 110 having a positive polarity include protruding center portions 110a, the protruding edge portions 110b, and grooves 110c formed between the center portions 110a and the edge portions 110b. The center portions 110a of the bare cells 110 are connected to the electrode terminals 150 through the electrode blocks 140. That is, the electrode blocks 140 are in contact with the center portions 110a. However, since the ends of the bare cells 110 include the grooves 110c, if the battery pack 1 vibrates, a short circuit may occur at the electrode blocks 140. If the battery pack 1 receives an external force, the electrode blocks 140 may be moved. In this case, the electrode blocks 140 may be separated from the center portions 110a and moved to or brought into contact with the edge portions 110b or the grooves 110c, causing a short circuit between the electrode blocks 140 and the bare cells 110.

The openings 131 of the electrode tabs 130 may be aligned with the center portions 110a, and the electrode tabs 130 may be supported on the edge portions 110b. Protrusions 142 of the electrode blocks 140 may contact the center portions 110a of the bare cells 110 through the openings 131 of the electrode tabs 130. That is, the electrode tabs 130 may be disposed between the bare cells 110 and the electrode blocks 140 to define regions through which the electrode blocks 140 contact the ends of the bare cells 110. Since the protrusions 142 of the electrode blocks 140 contact the bare cells 110 through the openings 131, the contact between the electrode blocks 140 and the bare cells 110 may be stably maintained. The electrode tabs 130 may be formed of an insulating material and prevent an electrical short circuit between the ends of the bare cells 110 and the electrode blocks 140.

The electrode blocks 140 may contact both ends of the bare cells 110. The electrode blocks 140 are disposed on the first side 121 and the second side 122 and connected to both ends of the bare cells 110. The electrode blocks 140 may include bodies 141, the protrusions 142, slots 143, and connection portions 144.

The electrode blocks 140 may connect the bare cell units U1 to U4 in series or directly connected to the electrode terminals 150 for connecting the bare cells 110 to the electrode terminals 150. The number of the electrode blocks 140 is not limited. For purposes of illustration, the following description refers to an embodiment in which the electrode blocks 140 include first to fifth electrode blocks 140a to 140e.

The first electrode block 140a may be disposed on the first side 121 of the housing 120 and may connect the first bare cell unit U1 to a first electrode terminal P1. The second electrode block 140b may be disposed on the second side 122 of the housing 120 and may connect the first bare cell unit U1 and the third bare cell unit U3 in series. The third electrode block 140c may be disposed on the first side 121 of the housing 120 and may connect the third bare cell unit U3 and the fourth bare cell unit U4 in series. The fourth electrode block 140d may be disposed on the second side 122 of the housing 120 and may connect the second bare cell unit U2 and the fourth bare cell unit U4 in series. The fifth electrode block 140e may be disposed on the first side 121 of the housing 120 and may connect the second bare cell unit U2 to a second electrode terminal P2 so that a polarity of the second electrode terminal P2 may be different from a polarity of the first electrode terminal P1.

Due to the protrusions 142 protruding from the electrode blocks 140, the electrode blocks 140 may make contact with both ends of the bare cells 110. Some of the protrusions 142 make contact with ends of the bare cells having a positive polarity through the openings 131 of the electrode tabs 130. The remaining protrusions 142 directly make contact with the other ends of the bare cells 110 having a negative polarity.

The slots 143 are formed in the vicinities of the protrusions 142 to allow elastic movement of regions of the bodies 141 having the protrusions 142. The slots 143 may be formed through the bodies 141 in a T-shape or H-shape, for example. Due to the slots 143, regions of the bodies 141 in which the protrusions 142 are formed may function as elastic tabs. That is, due to the elasticity of the elastic tabs formed by the slots 143, the contact between the protrusions 142 and both ends of the bare cells 110 may be stably maintained.

The connection portions 144 may extend toward the electrode terminals 150 and may be directly connected to the electrode terminals 150. First tabs 144a of the connection portions 144 may be bent from the bodies 141 and supported by an outer side of the housing 120. Second tabs 144b of the connection portions 144 may be bent from the first tabs 144a and connected to the first and second electrode terminals P1 and P2, respectively (refer to FIGS. 2 and 3).

The electrode blocks 140 may directly connect the bare cells 110 to the electrode terminals 150. In related art, a protective circuit module is disposed between bare cells and electrode terminals for controlling charging and discharging operations of the bare cells. In the battery pack 1 according to an exemplary embodiment of the present invention, however, the electrode blocks 140 directly connect the bare cells 110 to the electrode terminals 150 without a protective circuit module therebetween, and, thus, the volume and materials of the battery pack 1 may be reduced.

The electrode terminals 150 include the first electrode terminal P1 and the second electrode terminal P2 and form electrical contacts for connection with an external peripheral device. The first electrode terminal P1 may be connected to the first electrode block 140a and may have the first polarity. The second electrode terminal P2 may be connected to the fifth electrode block 140e and may have the second polarity. The first and second electrode terminals P1 and P2 may be connected to a peripheral device such as a generator module, a starter motor, or an electric load.

In the battery pack 1 according to an exemplary embodiment of the present invention, the electrode tabs 130 are disposed between ends of the bare cells 110 and the electrode blocks 140 so as to stably maintain the contact between the electrode blocks 140 and the bare cells 110.

In the battery pack 1 according to an exemplary embodiment of the present invention, the electrode blocks 140 may connect the bare cell units in series so as to provide a high voltage.

In the battery pack 1 according to an exemplary embodiment of the present invention, the electrode blocks 140 directly connect the bare cells 110 to the electrode terminals 150. Therefore, the size of the battery pack 1 may be reduced, and thus, the weight of the battery pack 1 may be reduced, and a space in a device including the battery pack 1 may be utilized more efficiently.

As described above, according to one or more exemplary embodiments of the present invention, a battery pack may have improved durability and may be used more safely. However, embodiments of the present invention are not limited to those described above.

Other aspects and effects of embodiments of the present invention may be understood from the above descriptions of some exemplary embodiments with reference to the accompanying drawings.

It should be understood that the exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the drawings, it will be understood by those of ordinary skill in the art that various changes in form and details may be made therein without departing from the spirit and scope of the present invention as defined by the following claims and equivalents thereof.

What is claimed is:

1. A battery pack comprising:
a plurality of bare cells;
a housing into which the bare cells are inserted in a first direction;
an electrode tab in contact with edge portions of first ends of bare cells of the plurality of bare cells and comprising a plurality of openings;
a plurality of electrode blocks arranged at both ends of the bare cells; and
electrode terminals directly connected to electrode blocks of the plurality of electrode blocks to allow the bare cells to be connected to an external device.

2. The battery pack of claim 1, wherein each of the electrode blocks comprises:
a protrusion; and
a slot proximate to the protrusion to allow a region of the electrode block including the protrusion to undergo an elastic deformation.

3. The battery pack of claim 2, wherein each of the electrode blocks further comprises a connection portion extending toward an electrode terminal of the electrode terminals and being directly connected to the electrode terminal.

4. The battery pack of claim 2, wherein each of the electrode blocks comprises a plurality of protrusions including the protrusion, protrusions of the plurality of protrusions being positioned in openings of the plurality of openings of the electrode tab.

5. The battery pack of claim 4, wherein the protrusions contact the first ends of the bare cells through the openings of the electrode tab.

6. The battery pack of claim 1, further comprising a case unit into which the housing is inserted in a second direction different from the first direction.

7. The battery pack of claim 6, further comprising an insulation cover between the housing and the case unit such that the electrode blocks contact the bare cells.

8. A battery pack comprising:
a housing;
a first bare cell unit inserted into the housing such that a first polarity end of the first bare cell unit is arranged at a first side of the housing;
a second bare cell unit inserted into the housing such that the second bare cell unit is arranged proximate to the first bare cell unit and a first polarity end of the second bare cell unit is arranged at a second side of the housing;
an electrode tab in contact with an edge portion of the first polarity end of the first bare cell unit and comprising a plurality of openings;
electrode terminals extending to an outer side of the housing to allow the first bare cell unit and the second bare cell unit to be connected to an external device; and
at least one electrode block electrically connecting the first and second bare cell units to each other or electrically connecting the first and second bare cell units to the electrode terminals.

9. The battery pack of claim 8, wherein each of the at least one electrode block comprises:
a protrusion; and
a slot proximate to the protrusion to allow a region of the electrode block including the protrusion to undergo an elastic deformation.

10. The battery pack of claim 9, wherein each of the electrode blocks comprises a plurality of protrusions including the protrusion, protrusions of the plurality of protrusions being positioned in openings of the plurality of openings of the electrode tab.

11. The battery pack of claim 9, wherein the protrusions contact the end of the first bare cell unit through the openings of the electrode tab.

12. The battery pack of claim 8, wherein the first and second bare cell units are connected in series.
